(19) United States
(12) Patent Application Publication
(10) Pub. No.: US 2013/0139701 A1
(43) Pub. Date: Jun. 6, 2013

(54) REMOVABLE FILTRATION DEVICE, PARTICULARLY FOR A CONTAINER SUCH AS A BOTTLE

(71) Applicant: Pierre MARCONI, Villeneuve Loubet (FR)

(72) Inventor: Pierre MARCONI, Villeneuve Loubet (FR)

(21) Appl. No.: 13/311,317

(22) Filed: Dec. 5, 2011

(51) Int. Cl. B01D 35/04; A47J 31/46; B01D 35/143; B01D 27/00; B01D 35/30

(52) U.S. Cl. 99/296; 210/184; 210/469; 210/85

(57) ABSTRACT

Filtration device for a closed container having a lower element and an upper element provided with an evacuation opening, the upper element adapted to be fixed in a sealed manner on the lower element; an internal filtration device including a reservoir provided with an opening in its upper portion allowing for its content to flow when the container is tilted toward the left or right; a filter, a filter support adapted to receive in a sealed manner the upper portion of the filter and the reservoir, a structural element cooperating with the filter support to define an intermediary volume adapted to receive the liquid after it has flowed through the opening, the structural element including a channel for the liquid to flow upward; the internal filtration device being arranged inside the container so as to enable collection of filtered liquid after passage through the filter.

### TECHNICAL FIELD OF THE INVENTION

The present invention relates to a water filtration device and, in particular, to a removable filtration device for a container such as a bottle.

### STATE OF THE ART

The market of filtration carafes is drastically developing. It is to be remembered that a filtration carafe is generally composed of a main body provided with a lid and is used as a main reservoir for storing water. The body of the carafe further comprises a secondary reservoir adapted to hold water waiting to be treated associated with a filter or a filtration cartridge for purifying the water situated in the secondary reservoir.

Filtration carafes are effective. However, they are generally bulky, are not hermetic, and, most of all, are adapted only for home use. In addition, the water arranged in the secondary reservoir is treated in a single operation; the chlorine being eliminated, the filtered water is required to be consumed rapidly to prevent bacteria from developing.

Consequently, such carafes are not adapted for portable use, outside of the home.

A certain number of solutions allowing for making filtration bottles for portable use are already known.

For example, the American patent U.S. Pat. No. 4,151,092 entitled “Portable Water filter” describes a filter comprising a first cylindrically shaped container for holding the water to be purified, a filter cartridge and a second cylindrical container to hold the purified water. The water purification operation is carried out by a manual “pumping” operation resulting from the telescopic insertion of the second container within the first container.

The American patent U.S. Pat. No. 4,477,347 entitled “Portable Water Purifier” describes a portable water purifier comprising a container provided with a removable filter, a chamber comprising water to be purified, and a pump system arranged at the top of the purifier.

The American patent U.S. Pat. No. 5,417,860 describes a filtration device which is inserted in the mouth of a bottle containing water to be treated.

The American patent U.S. Pat. No. 5,431,813 describes a bottle provided with a filtration system in its upper portion.

The American patent U.S. Pat. No. 5,840,185 is another example of such a filtration cartridge adapted to be arranged on the neck of a container such as a bottle.

The American patent U.S. Pat. No. 6,136,189 describes a filtration mechanism arranged inside a bottle.

All these known solutions have certain advantages but do not provide for the filtered water to be distributed “on-demand” and for the whole to be made simply and in a cost-effective manner.

Such is the problem to be solved by the present invention.

### BRIEF SUMMARY OF THE INVENTION

The object of the present invention is a filtration device for a receptacle or a container, such as a bottle, for example, allowing for filtered water to be distributed at the last moment, that is, right before being immediately consumed by the user.

Another object of the invention consists of proposing a filtration device avoiding the proliferation of bacteria within the filtered water.

Another object of the present invention is to provide a removable filtration device for various containers, allowing the filtration to be controlled or stopped. The invention accomplishes these goals by means of a filtration device comprising:

a container comprising a lower element and an upper element provided with an evacuation opening, the upper element can be fixed in a sealed manner on the lower element so as to constitute a closed container which can have, for example, the shape of a bottle. The device comprises an internal filtration system comprising:

a reservoir provided with an opening in its upper portion allowing for its content to flow when the container is tilted toward the left (or alternatively toward the right for left-handed users);

a filter;

a filter support adapted to receive in a sealed manner the upper portion of the filter and the reservoir;

a structural element cooperating with the filter support so as to define an intermediary volume allowing for receiving the liquid after it has flowed through said opening, the structural element further comprising a channel for the liquid to flow upward.

The internal filtration system is arranged inside the container so as to enable the filtered liquid to be collected after passage through the filter.

In a particular embodiment of the invention, the internal reservoir further comprises a receptacle for holding tea or infusion herbs usable during the collection of filtered water in the lower portion of the container.

Preferably, the container has the shape of a bottle provided with a mouth having a plug, and the structural element has a cylindrical shape, the flow channel of the structural element being delimited by a double partition, internal and external.

In a particular embodiment, the reservoir and the filter are both cylindrically shaped and the filter support has a circular shape adapted to the internal cross-section of the structural element. The filter support further has two circular openings allowing for receiving the upper head of the filter and the body of the reservoir, respectively, the assembly formed by the structural element, the filter support, the filter and the reservoir delimiting said intermediary volume.

In a particular embodiment, the filter support can be arranged at various predetermined heights.

Preferably, the device comprises a system for counting the number of uses of the filter.

The device can have any shape, for example, the shape of a flask, a can, or simply the shape of a bottle.

### BRIEF DESCRIPTION OF THE DRAWINGS

Other characteristics, goals, and advantages of the invention will be better understood from the description and drawings that follow, given only by way of non-limiting examples. In the annexed drawings:

FIGS. 1a and 1b show an embodiment of a filtration device according to the invention.

FIG. 2 shows a schematic view of different elements constituting the embodiment of FIGS. 1a and 1b, in situ.

FIGS. 3a, 3b, 3c, and 3d show the various flows during use of the device of FIGS. 1a and 1b.

FIGS. 4a, 4b, 4c, and 4d show another embodiment allowing for the preparation of an infusion or a tea from filtered water.

### DETAILED DESCRIPTION OF THE PREFERRED EMBODIMENTS

A particular embodiment of the invention adapted to make a bottle provided with an autonomous and removable filtration device allowing purified water to be distributed “on-demand” will now be described.

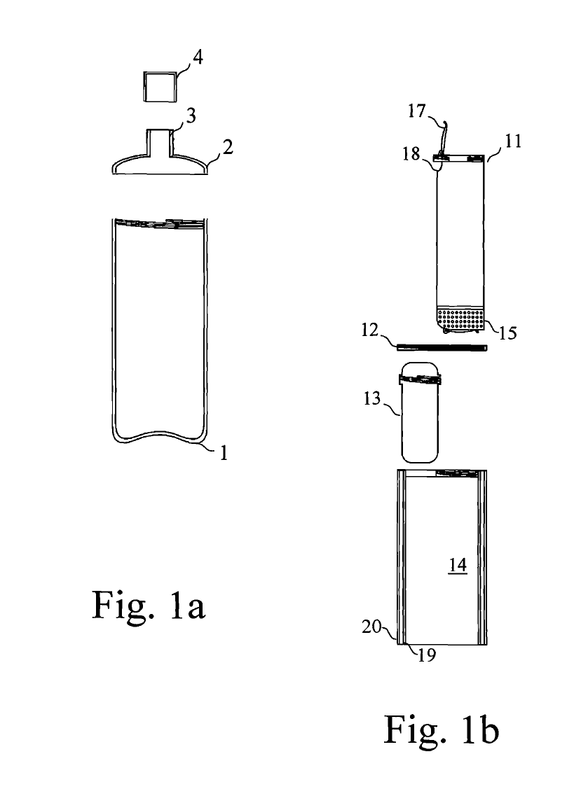

FIG. 1a thus shows a bottle composed of two elements: a lower element 1 and an upper element 2.

The lower element 1 has the well-known shape of a bottle, a carafe (in the shape of a Ricard® carafe—registered mark), a can having a large capacity, or any other container for collecting filtered water and for receiving the filtration system described hereinafter.

In the preferred embodiment, the lower element is provided, in its upper portion, with a threading for screwing the upper element 2.

In the embodiment shown in FIG. 1a, the upper element 2 has the shape of the upper portion of a bottle, with a mouth 3 and a screw plug 4.

When the two elements 1 and 2 are joined, they form a container having the shape of a perfectly sealed bottle. Conversely, when the elements 1 and 2 are detached, the internal filtration system can be easily accessed, which is now described in relation to FIG. 1b.

The filtration device comprises an internal reservoir 11 adapted to receive the non-treated water and preferably provided with a closing cap 17.

The reservoir 11 comprises, in its left upper portion, an opening enabling—when the bottle is tilted to “the left”—the flow by gravity of the water contained in the body of the reservoir 11 to collect it within an intermediary volume 16 described in more detail hereinafter, to then filter it immediately.

In a particular embodiment, the reservoir 11 further comprises, optionally, a receptacle 15 which can be clipped or fastened by any appropriate means and adapted to receive a dose of tea or aromatic herbs or to be infused in order to enable, if need be, the preparation of an aromatic drink, an infusion, or simply tea.

The filtration device further comprises a filter 13 which can be any filter or filter cartridge sold by a manufacturer. FIG. 1b shows the use of a cylindrically shaped filter.

The filtration device further comprises a filter support 12 for maintaining the reservoir 11 and the filter 13, as well as a structural element 14 having a shape adapted to that of the lower element 1 of the bottle.

In the embodiment shown in FIG. 1b, the structural element 14 is cylindrical, an upper lid provided with an aperture for the passage and maintaining of the reservoir 11, and two walls, internal 19 and external 20, respectively, delimiting a cylindrical channel for the treated water to flow upward when the bottle is tilted.

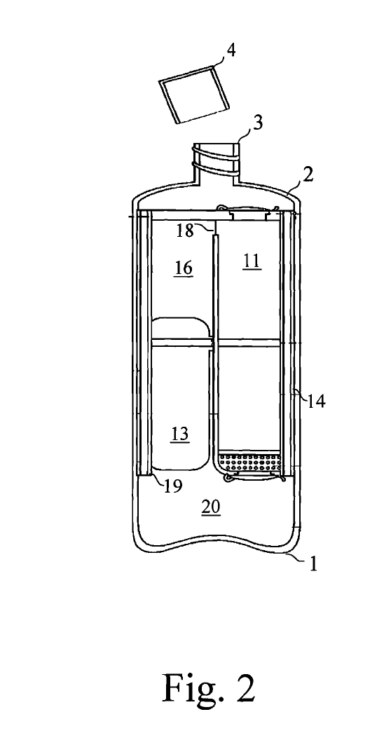

When the reservoir 11 and the filter 13 are kept in place by the filter support 12, the latter cooperates with the structural element 14 so as to delimit, as shown in FIG. 2, a reservoir or intermediary volume 16 for receiving the water having flowed from the reservoir 11 through the opening 18 when the bottle is tilted toward the left.

To this end, the filter support 12 has a circular shape adapted to the cross-section of the structural element 14, so as to enable the constitution of a sealed volume. Preferably, the filter support 12 has a surface adapted to the cross-section of the cylinder constituted by the internal wall of the structural element 14. A fastening element (not shown in the drawing) such as a boss or a groove on the structural element 14 allows the filter support 12 to be kept in place.

In addition, the filter support 12 is provided with two apertures, generally cylindrically shaped, adapted to receive the reservoir 11 and the filter 13 respectively, and to maintain them solidly in place, as shown in FIG. 2, while ensuring the intermediary volume 16 which will be delimited is sealed.

Several means, by pushing down or screwing, can be used to ensure the reservoir 11 and the filter 13 are strongly fastened to the filter support 12.

Optionally, to improve the stability of the reservoir 11, the latter can also be fastened by any appropriate means to the structural element 14.

Regarding the filter 13, the latter is fastened, as previously described, to the filter support 12 which is provided with an opening adapted to this filter. The filter can thus be changed easily, for example by unscrewing.

In addition, it can be seen that the device allows for an advantageous modularity since it is possible to provide several types of filter supports 12 so as to be adaptable to several models of filters existing on the market.

As mentioned, the filter support 12 has an important and particularly advantageous function, namely, as shown in FIG. 2, it makes it possible to delimit an intermediary volume 16 defined by the upper portion of the filter 13, the internal wall 19 of the structural element 14, and the external surfaces of the reservoir 11.

This intermediary volume 16, delimited during the setting in place of the various elements hereinabove described, makes it possible to collect water before the latter is immediately treated by the filter 13, whereas the water remaining in the reservoir 11 stays therein without being treated.

Therefore, as can be seen, the invention allows for making, in a very simple manner and with a minimum of internal pieces, a filtration system in which the filtration process can be started or stopped, very simply, by tilting the bottle to the left (resp. to the right), so as to cause, or not, the water to flow from the reservoir 11 up to inside the intermediary collection volume 16.

The filter support 12 thus ensures three different and perfectly appropriate functions:
maintaining the reservoir 11 in place so it remains positioned in the upper portion of the bottle, as seen in FIG. 2;
maintaining the filter 13 in place so it also remains positioned in the upper portion of the bottle and treats the water collected in the internal volume 16;
delimiting the intermediary volume 16 for collecting the flow water via the upper left opening 18 of the reservoir 11.

This perfectly advantageous arrangement thus makes it possible to prevent the filter 13 from stagnating in the water during the displacement of the bottle. It also ensures that the water is filtered at the appropriate time, chosen, in general, right before its consumption.

In a particular embodiment, the filter support 12 can be fastened to the structural element at different predefined positions—for example by means of a set of predetermined grooves—to enable the adjustment at will of the quantity of water filtered and collected in the lower portion of the element 1.

In a particular embodiment, the filter support 12 or the structural element 14 comprises a counting system for counting the number of uses of the filter and thus facilitate the management of the latter . . . in the most simple form, a system of visual gradation can be provided to enable the identification of the date of first use of the filter.

For clarity purposes, the different flows during the use of the filtration bottle of FIG. 2 are now described.

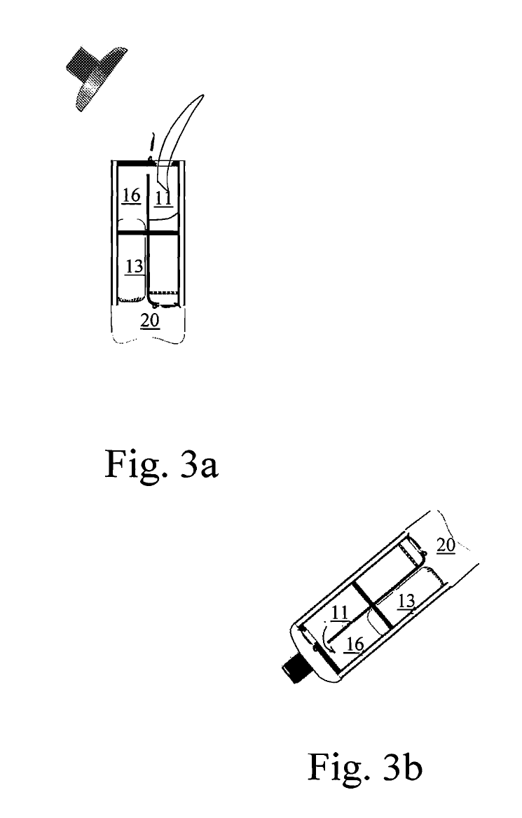

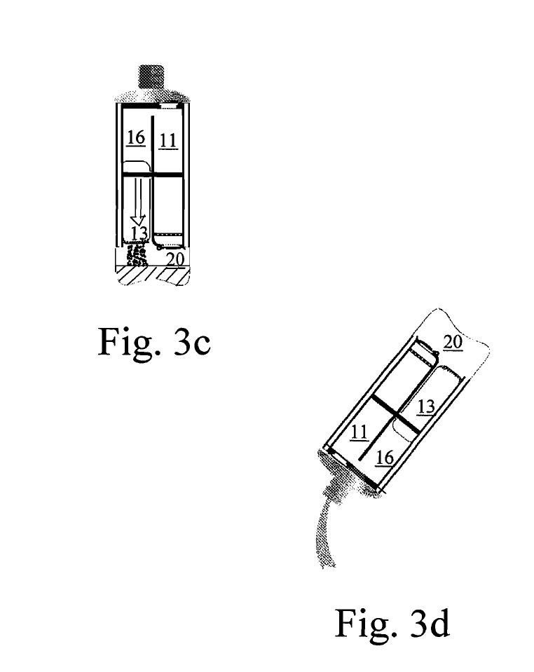

FIG. 3a shows that the user fills the reservoir 11 with water to be filtered. In case of immediate consumption, the volumes 11 and 16 can be completely filled up in order to treat a maximum volume of water.

Conversely, in a portable use, only the volume 11 is filled so as to be able to differ the beginning of the filtration process. The bottle can thus be transported to the place of consumption even when temperatures are high and susceptible to favor the development of bacteria.

Indeed, at the time of consumption, the user only has to tilt the bottle to the left, as shown in FIG. 3b, thus causing a flow via the opening 18 of part of the liquid contained in the reservoir 11, which is then collected in the volume 16 to be filtered therein by the filter 13.

FIG. 3c thus shows the passage of the water within the filter to be subsequently collected therein in the lower volume 20 of the bottle.

It must be noted, and this is a particularly interesting advantage of the invention, that it suffices to “tilt” the bottle again toward the right to stop the filtration and thus prevent filtered water from stagnating within the volume 20.

When the user desires to consume the filtered water, it suffices to tilt the bottle, either toward the right (if the user wants to interrupt the production of filtered water), or toward the left (if the user wants to pursue the production of filtered water), allowing for the flow along the volume delimited by the two surfaces, internal 19 and external 20, of the structural element 14.

The filtration bottle according to the invention thus allows for great flexibility and provides “on-demand” water filtration, that is, at the time of consumption by protecting the filtered water from the development of bacteria.

Conversely, the known devices filter water immediately and store the water that has been rid of chlorine, thus favoring the proliferation of bacteria.

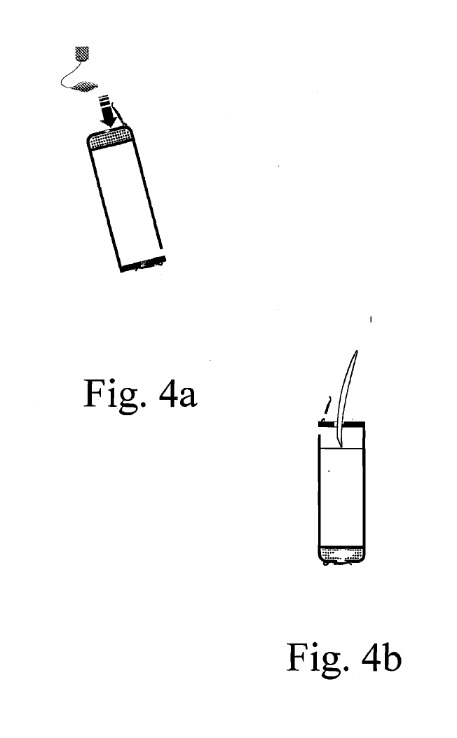

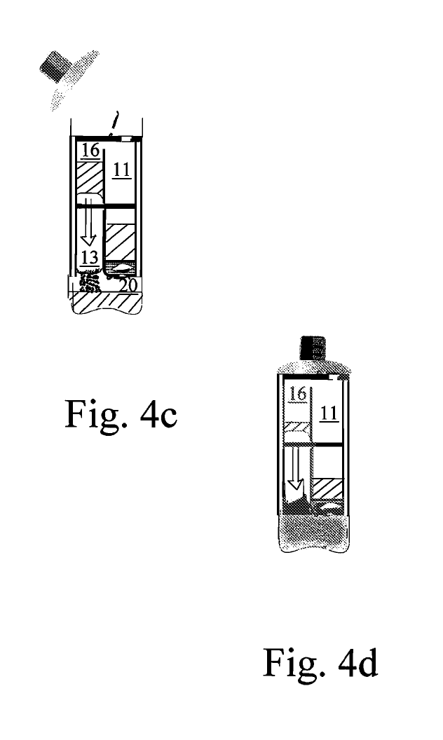

FIGS. 4a to 4d show the functioning of the filter during the preparation of tea or of some infusion. As shown, tea or infusion herbs are placed in the infuser 15 and the reservoir 11 is subsequently filled with water. Tilting the bottle toward the left causes the water to flow in the volume 16 to then be filtered therein by the filter 13. Once collected at the bottom of the volume 20, the purified water can thus immerse the dose of tea contained in the infuser.

Generally, the body of the bottle can be made of a transparent plastic material so as to provide a direct sight of the purified water and to enable the user to cease the production of water when the level is sufficient.

An embodiment of the invention has been described in relation with a bottle for a portable use. Clearly, this is only a non-limiting example, since one having ordinary skill in the art can adapt the invention to make any other container, even a kettle allowing for filtering, then heating the water for immediate consumption.

The invention can generally be used to make any container such as a carafe, a flask, a jug . . .

Similarly, the embodiment which has been described shows the filtration being controlled by the fact of tilting the bottle toward the left. This configuration can easily be adapted and the opening 18 of the reservoir 11 can be arranged on the right, so as to cause the flow by gravity of the water contained in the reservoir 11 by tilting the bottle to the right.

I claim:

1. Filtration device for a container comprising:
a container comprising a lower element (1) and an upper element (2) provided with an evacuation opening (3), the upper element able to be fixed in a sealed manner on the lower element so as to constitute a closed container;
an internal filtration device comprising:
a reservoir (11) provided with an opening in its upper portion allowing for its content to flow when the container is tilted toward the left or toward the right;
a filter (13);
a filter support (12) adapted to receive in a sealed manner the upper portion of the filter (13) and the reservoir (11);
a structural element (14) cooperating with the filter support (12) so as to define an intermediary volume (16) allowing the liquid to be received after it has flowed through said opening (18), the structural element further comprising a channel for the liquid to flow upward;
said internal filtration device being arranged inside the container so as to enable the filtered liquid to be collected after passage through the filter.

2. The device of claim 1, wherein the internal reservoir (11) further comprises an infuser to maintain tea or infusion herbs usable during the collection of filtered water in the lower portion of the container.

3. The device of claim 1, wherein the container and the structural element (14) have a cylindrical shape, the flow channel of the structural element being delimited by a double partition, internal (10) and external (20).

4. The device of claim 3, wherein the reservoir (11) and the filter (13) have a cylindrical shape and in that the filter support 12 has a circular shape adapted to the internal cross-section of the structural element (14) and has two circular openings allowing for blocking the upper head of the filter (13) and the body of the reservoir (11), the assembly formed by the structural element (14), the filter support (12), the filter (13) and the reservoir (11) delimiting said intermediary volume (16).

5. The device of claim 1, wherein the filter support can be arranged at predetermined variable heights.

6. The device of claim 1, further comprising a system for counting the number of uses of the filter.

7. The device of claim 1, further comprising a heating system for the production of filtered hot water.

8. The device of claim 1, wherein said container has the shape selected from the group consisting of a flask, a carafe, and a can.

9. The device of claim 1, wherein the container comprises an upper element which can be screwed on a lower element so as to have, once the two elements are united, the shape of a bottle.

10. The device of claim 1, wherein the flow of the content of the reservoir in the intermediary volume is carried out when the container is tilted toward the left.
